(19) United States
(12) Patent Application Publication
(10) Pub. No.: US 2005/0270120 A1
(43) Pub. Date: Dec. 8, 2005

(54) Dielectric resonator filter and multiplexer

(76) Inventor: Jiunn-Sheng Guo, Newark, DE (US)

Correspondence Address: KEVIN J. MCNEELY, ESQ., 5335 WISCONSON AVENUE, NW, SUITE 440, WASHINGTON, DC, 20015, US

(21) Appl. No.: 11/134,314

(22) Filed: May 23, 2005

Related U.S. Application Data
(60) Provisional application No. 60/575,836, filed on Jun. 2, 2004.

(51) Int. Cl. H01P 1/213; H01P 1/20

(52) U.S. Cl. 333/134; 333/202

(57) ABSTRACT

A dielectric filter includes at least two dielectric resonators, a housing, and a support rod supporting the dielectric resonators and attached to the housing. The support rod may include a first end and a second end attached to the housing. A method of manufacturing a dielectric filter includes fixing dielectric resonators to a support rod and attaching each end of the support rod to a housing.

### CROSS REFERENCE TO RELATED APPLICATION

This patent application claims priority to U.S. patent application Ser. No. 60/575,836 filed on Jun. 2, 2004.

### FIELD OF INVENTION

This invention is related to telecommunications filter technology, and more particularly, to dielectric resonator filters.

### BACKGROUND

High Q dielectric (HQD) band pass filters need extremely low in-band insertion loss, steep skirt slope and high out-of-band rejection. HQD band reject filters must have high in-band rejection, steep skirt slope and low out-of-band insertion loss.

FIG. 1 shows a conventional HQD filter 1. In the conventional filter, four dielectric “pucks” 2 are each fastened to separate support rods 3 either by epoxy or by using fastening screws and each support rod is attached to a housing 4. Installing an individual support rod 3 for each resonator puck 2 is a complex and/or time consuming assembly procedure. In addition, since only one end of each support rod 3 is secured to the housing, such a cantilevered structure is subject to vibration or shock damage thereby causing filter failure or performance degradation. Thus, a need exists for an improved HQD resonator filter.

### BRIEF DESCRIPTION OF THE DRAWINGS

FIGS. 1a and 1b respectively show a top view and a longitudinal cross sectional view of the prior art conventional HQD filter.

FIGS. 2a, 2b and 2c, respectively show a top view, a longitudinal cross sectional view, and a transverse cross sectional view of the HQD filter of the present invention.

FIG. 3 shows a longitudinal cross sectional view of a four pole HQD filter embodying the present invention.

FIGS. 4 and 5 show top views of eight pole HQD filters embodying the present invention.

FIG. 6 shows a housing for an eight pole HQD filter embodying the present invention.

FIG. 7 shows a lid attached to the housing of FIG. 6.

FIG. 8 shows a housing for the eight pole HQD filter of FIG. 4.

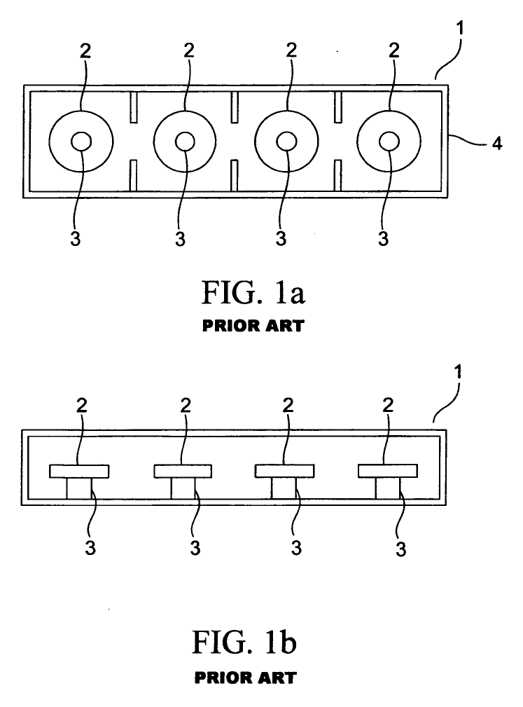

### SUMMARY

The present invention uses a single support rod to support all pucks or a series of support rods that each supports more than one puck. Each end of the support rod is mounted to the housing to firmly secure the pucks. This provides excellent shock and vibration durability and improved filter performance. Filter tuning is achieved by inserting set screws with a high dielectric constant inside the support rod or by the use of other types of tuning assemblies that are used with conventional HQD filters. The filter is tuned to optimal performance by gradual adjustment of the set screws.

In one general aspect, a dielectric filter includes at least two dielectric resonators, a housing, and a support rod supporting the dielectric resonators by attachment to the housing. Embodiments may include one or more of the following features. For example, the support rod may include a first end and a second end attached to the housing. As another example, the housing may be made of metal or of a dielectric with metal plating.

The dielectric filter may include a tuning apparatus attached to the housing that tunes the resonator frequency along with input and output connectors attached to the housing.

Each dielectric resonator can be a dielectric puck that may have a threaded center hole. The dielectric resonators may be made of ceramic materials that have a dielectric constant greater than 20, a loss tangent less than 0.0005, and a thermal expansion coefficient in the range of −5 ppm/c to +5 ppm/c. The dielectric resonators may be operated in single mode TEH, single mode T, dual mode, or triple mode.

The support rod may be made of a dielectric material and may have a threaded outer surface that is inserted through a center hole of each of the dielectric resonators. Dielectric nuts may be threaded onto the threaded outer surface thereby fixing the position of the dielectric resonators on the support rod. The support rod may also be a dielectric tube with a threaded outer surface in which case the dielectric resonators are threaded onto the threaded outer surface to fix the dielectric resonators to the support rod. The dielectric tube may also have a threaded central bore with tuning screws inserted into the threaded central bore to fine tune the dielectric resonators.

In another general aspect, a dielectric filter includes a plurality of dielectric resonators and a plurality of dielectric rods, with each of the dielectric rods supporting more than one of the dielectric resonators. Embodiments may include one or more of the above or following features. For example, each dielectric rod may have a threaded outer surface, and dielectric nuts may be used to fix the dielectric resonators to the dielectric rods. The dielectric rods and the dielectric nuts may have a dielectric constant ranging from 1.5 to 6, a loss tangent ranging from 0.005 to 0.00005, and a thermal expansion coefficient ranging from −10 ppm/c to +10 ppm/c.

The dielectric filter may include a housing and both ends of the dielectric rods may be fixed to the housing. Tuning assemblies may be attached to the housing or to a housing cover with a tuning assembly proximate to each of the dielectric resonators. Each tuning assembly may include a tuning screw made of metal, lock nuts made of metal, and a tuning plate or disc that is made of a ceramic material and that has a circular shape.

In another embodiment, a series of dividing walls define separate compartments within the housing thereby partially isolating a dielectric resonator in each of the separate compartments. A cross coupling apparatus may also be used to couple pairs of partially isolated dielectric resonators. The cross coupling apparatus may include a coaxial transmission line having rods extending from an inner conductor, a plate attached to the inner conductor of the coaxial transmission line, and a ring attached to the inner conductor of the coaxial transmission line and to an outer connector of the coaxial transmission line.

In another general aspect, a diplexer includes a housing, a receive bandpass filter that includes twelve ceramic dielectric resonators mounted to receive channel support rods, and a transmit bandpass filter that includes six metal dielectric resonators on a transmit channel support rod. Each end of the receive channel support rods and the transmit channel support rod is attached to the housing. Embodiments may include one or more of the above features.

In a further general aspect, a method of manufacturing a dielectric filter includes fixing dielectric resonators to a support rod and attaching each end of the support rod to a housing.

### DETAILED DESCRIPTION

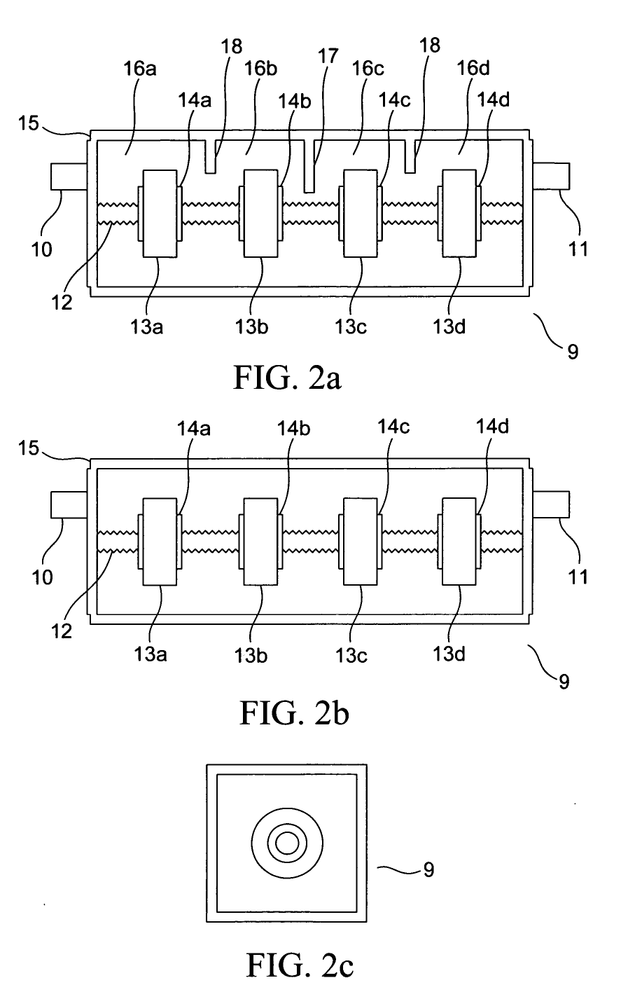

The present invention uses multiple dielectric resonators on a common support rod with each end of the support rod mounted to a housing. FIGS. 2a, 2b, and 2c show an embodiment of the HQD band-pass filter 9 of the present invention. Referring to FIG. 2a, a radio frequency (RF) input connector 10 and an RF output connector 11 are attached to the outside of the housing 15. The housing 15 is a rectangular box with an open top and can be made of metal, such as, for example, aluminum with silver plating.

A support rod 12 is positioned in the housing 15 with each end of the support rod 12 attached to the housing 15. The support rod 12 may be attached to the housing 15 by spot welds, an adhesive, hardware, or a combination thereof. The support rod 12 has a threaded outer surface and is made of teflon or other similar material.

Dielectric resonator pucks 13a, 13b, 13c, and 13d are secured to the support rod 12 by inserting the support rod 12 through the center hole of each puck 13a-13d. Locking nuts 14a, 14b, 14c, and 14d are threaded onto the support rod 12 and are positioned on either side of each puck 13a-13d to fix the pucks 13a-13d at intervals along the length of the support rod 12. The locking nuts 14a-14d are typically made of plastic or any other non-metallic material. In other embodiments, the pucks are adhered to the support rod by an adhesive or the pucks have threaded center holes to secure each puck to the support rod 12. The pucks 13a-13d are made of ceramic or any other suitable material, such as, for example, metal. In one embodiment, the ceramic material has a dielectric constant greater than 20, a loss tangent less than 0.0005, and a thermal expansion coefficient in the range of −5 ppm/c to +5 ppm/c.

FIG. 2a shows the housing 15 divided into compartments 16a, 16b, 16c, and 16d by a large dividing wall 17 and two small dividing walls 18 in order to reduce the coupling between the pucks 13a-13d. FIGS. 2b and 2c shows the housing without compartments.

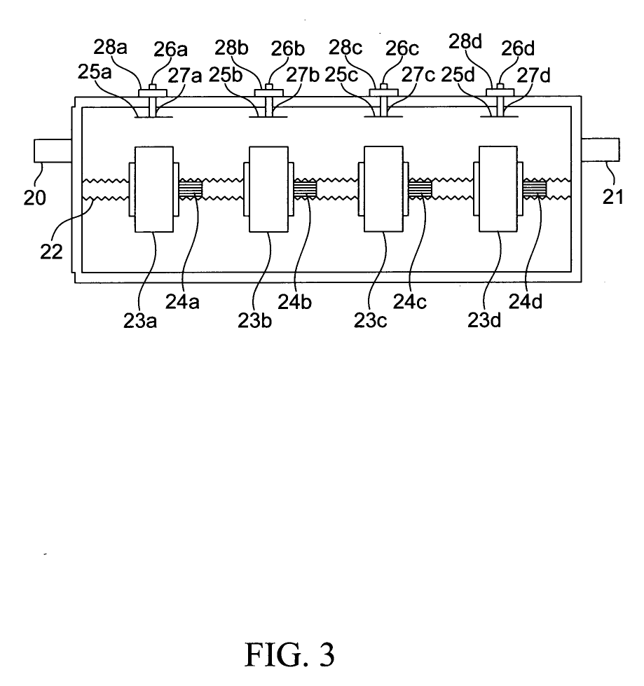

FIG. 3 shows another embodiment of the present invention. The support rod 22 has a threaded central bore with dielectric set screws 24a, 24b, 24c, and 24d threaded into the central bore. Each set screw 24a-24d is positioned proximate to each puck 23a-23d. Movement of the dielectric set screws 24a-24d adjusts the frequency of each of the respective resonator pucks 23a-23d. Additional tuning screws (not shown) may be located between the resonator pucks 23a-23d to adjust the coupling between adjacent resonator pucks 23a-23d.

In another embodiment, frequency tuning assemblies 26a, 26b, 26c, and 26d are installed on the housing (or on the lid) to fine-tune the frequency of the resonator pucks 23a-23d. Tuning assemblies 26a-26d include small tuning discs 25a, 25b, 25c, and 25d positioned at the ends of threaded shafts 27a, 27b, 27c, and 27d. Nuts 28a, 28b, 28c, 28d secure the positions of the shafts 27a-27d, which are rotated to move the tuning discs 25a-25d closer or further from the resonator pucks 23a-23d.

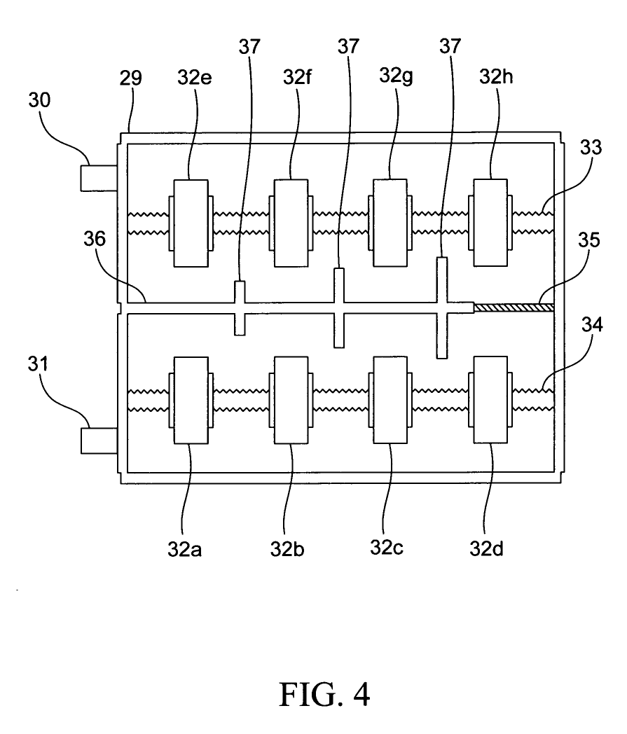

FIG. 4 is a top view of an eight pole HQD band pass filter. The input connector 30 and the output connector 31 are attached to the same end of the housing 29. Two support rods 33 and 34 each support four resonator pucks 32e-32h and 32a-32d, respectively. The rods 33, 34 are positioned in parallel and a dividing wall 36 isolates the support rods 33, 34. An aperture or iris 35 in the dividing wall 36 allows coupling between the two pucks 32d and 32h that are proximate to the iris 35.

The transmission path travels from left to right through the filter from the input connector and across the resonator pucks 32e-32h, respectively. The transmission path is then directed down through the aperture 35 from resonator puck 32h to resonator puck 32d. At that point, the transmission path changes direction and travels from right to left from resonator puck 32d and though resonator pucks 32c-32a, respectively, exiting at the output connector 31.

The size of the iris or aperture 35 may be varied depending on the desired frequency and bandwidth. In addition, the dimensions of separating walls 37 between adjacent pucks may also be changed to accommodate various frequencies and bandwidths.

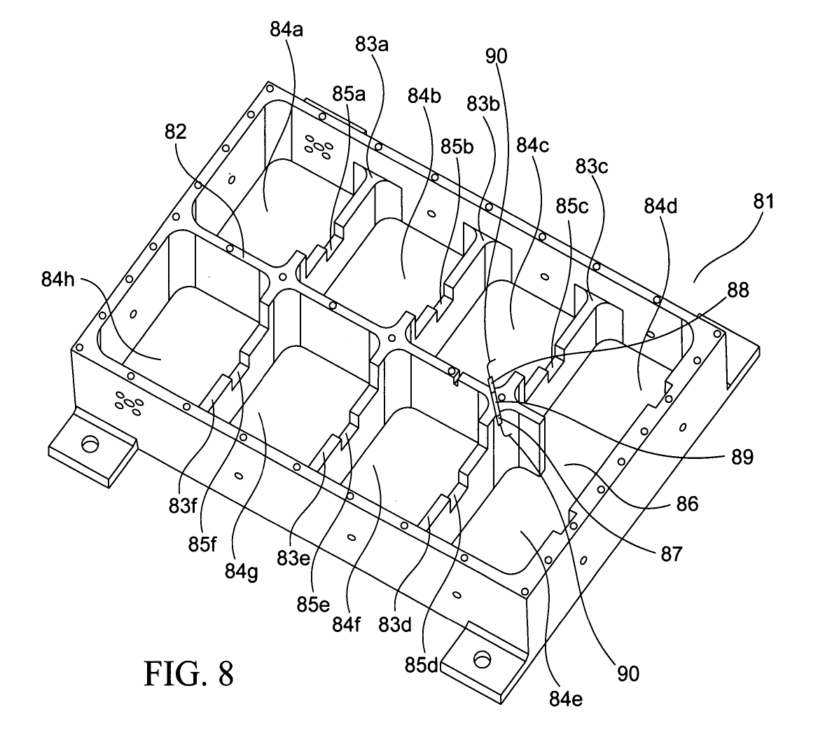

Similar to FIG. 4, FIG. 8 illustrates a housing 81 of an eight pole HQD filter configured to accommodate two parallel support rods (not shown). A main dividing wall 82 bisects the housing 81 and a series of lower walls 83a-83f further divide the housing into eight compartments 84a-84h. Each lower wall 83a-83f includes a notched area or iris 85a-85h. The support rods attach to each end of the housing and extend through the irises 85a-85c and 85d-85f. An opening 86 at one end of the dividing wall 82 allows coupling to occur between pucks adjacent to the opening 86 in compartments 84d and 84e.

A channel 87 in the dividing wall 82 may be used for a cross coupling apparatus 88 that couples pucks in compartments 84c and 84e. The cross coupling apparatus 88 may include a coaxial transmission line 89 having an extended inner conductor 90. A plate may be attached to the inner conductor of the coaxial transmission line 89, and a ring attached to the inner conductor 90 of the coaxial transmission line 89 and to an outer connector of the coaxial transmission line 89 (not shown).

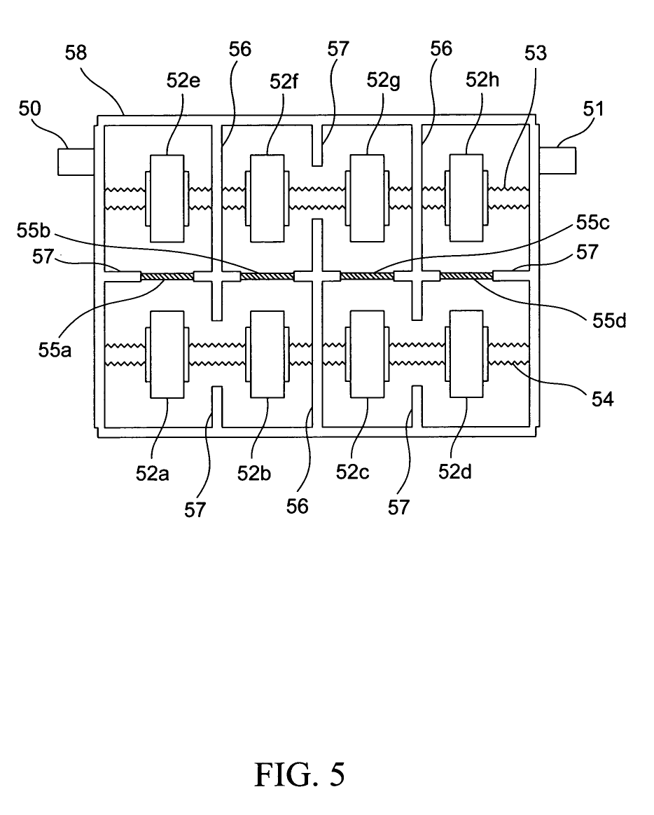

FIG. 5 is a top view of another embodiment of an eight pole HQD band pass filter with input and output connectors 50 and 51 on opposing ends of the housing 58. Four resonator pucks 52e, 52f, 52g, and 52h and 52a, 52b, 52c, and 52d are each positioned on parallel support rods 53 and 54, respectively. Three T-shaped dividing walls 56 and a set of smaller separating walls 57 partially isolate the resonator pucks 52a-52e. A series of openings 55a, 55b, 55c, and 55d between the walls 56, 57 provide a circuitous coupling path between adjacent pucks 52e and 52a, 52b and 52f, 52g and 52c, and 52d and 52h, respectively. Thus, the transmission path between the input connector 50 and the output connectors 51 goes from 52e to 52a to 52b to 52f to 52g to 52c to 52d to 52h.

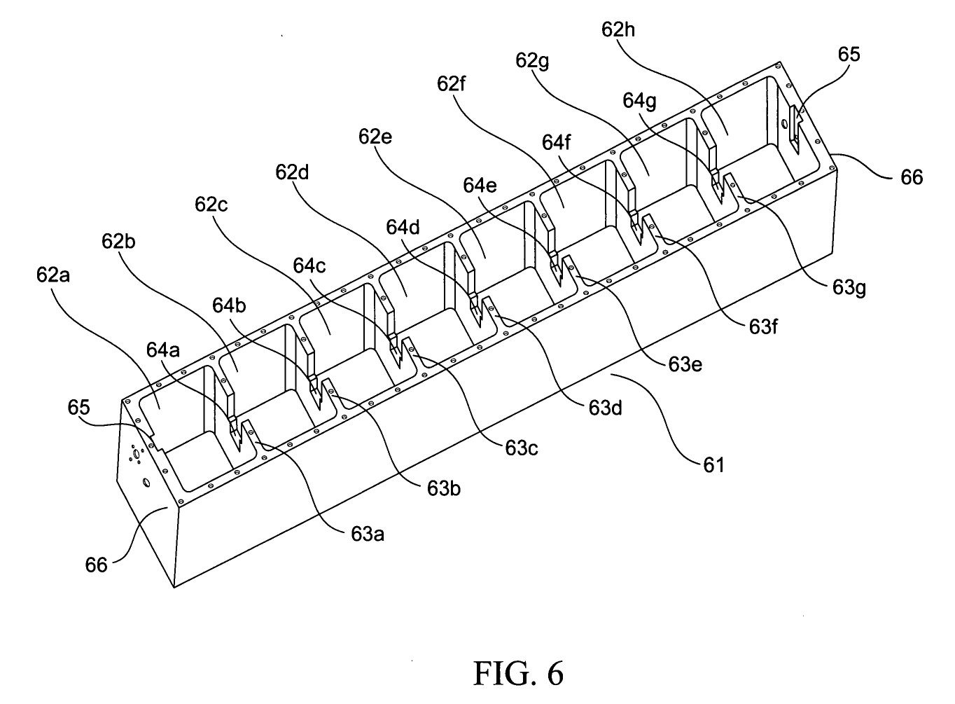

FIG. 6 refers to a housing 61 for another eight pole HQD band pass filter that employs a row of 8 pucks on a single rod (not shown). The housing 61 is divided into a series of compartments 62a, 62b, 62c, 62d, 62e, 62f, 62g, and 62h by a series of inner walls 63a, 63b, 63c, 63d, 63e, 63f, and 63g each having an iris 64a, 64b, 64c, 64d, 64e, 64f, and 64g. The support rod is positioned in a channel 65 in each end wall 66 of the housing and it passes through the irises 64a-64g between the compartments.

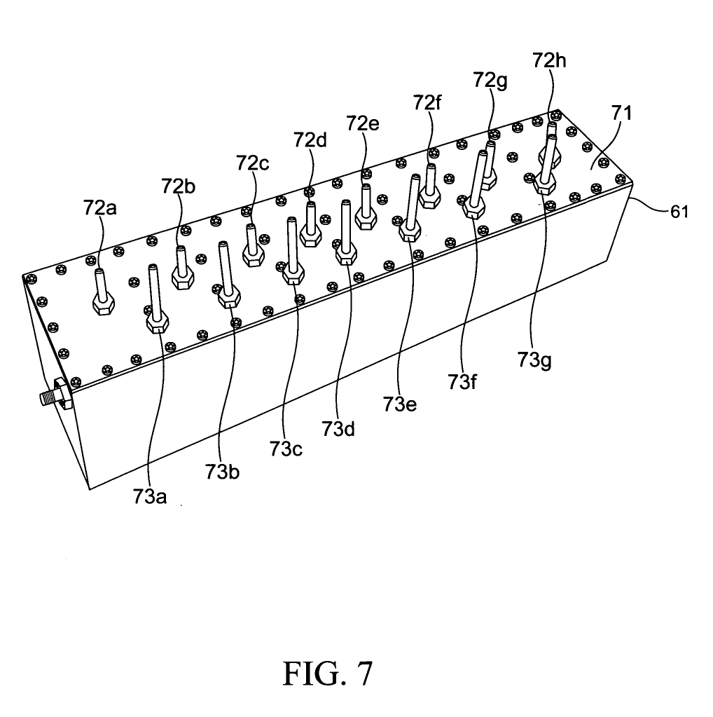

FIG. 7 shows the housing of FIG. 6 with the cover or lid 71 attached. The lid 71 has a series of tuning assemblies 72a-72h (similar to that described above with respect to FIG. 3) that tune each of the resonator pucks in compartments 62a-62h, respectively (as shown in FIG. 6). In addition, bandwidth tuning assemblies 73a-73g (as shown in FIG. 7) are positioned proximate to each iris 64a-64g, respectively, to fine tune the bandwidth of the filter. The configuration of the bandwidth tuning assembly is similar to that mentioned above with respect to the frequency tuning assemblies of FIG. 3.

The number of dielectric resonators used in the present invention is not limited. The dielectric resonators may operate in various modes, such as, for example, single mode TEH, single mode T, dual mode, or triple mode. Also, the fine tuning method and mechanical approach shown in FIG. 3 can be varied and/or can apply to all designs.

Various changes may be made in the above apparatus without departing from the scope of the invention herein involved. All matter contained in the above description or shown in the accompanying drawing should be interpreted in an illustrative and not in a limiting sense. For example, advantageous results still could be achieved if components in the disclosed systems were combined in a different manner and/or replaced or supplemented by other components. Accordingly, other implementations are within the scope of the following claims.

1. A dielectric filter comprising:
at least two dielectric resonators;
a housing; and
a support rod supporting the dielectric resonators, the support rod being attached to the housing.

2. The dielectric filter of claim 1, wherein the support rod comprises a first end and a second end, the first end and the second end being attached to the housing.

3. The dielectric filter of claim 1, further comprising:
a tuning apparatus attached to the housing to tune a resonator frequency of the resonators; and
an input connector and an output connector attached to the housing.

4. The dielectric filter of claim 1, wherein each of the dielectric resonators include a dielectric puck having a threaded center hole.

5. The dielectric filter of claim 1, wherein the dielectric resonators comprise:
ceramic materials with a dielectric constant greater than 20, a loss tangent less than 0.0005, and a thermal expansion coefficient in the range of −5 ppm/c to +5 ppm/c.

6. The dielectric filter of claim 1, wherein the dielectric resonators include a mode of operation comprising one of:
single mode TEH;
single mode T;
dual mode; or
triple mode.

7. The dielectric filter of claim 1, wherein:
the support rod comprises a dielectric rod having a threaded outer surface inserted through a center hole of each of the dielectric resonators; and
further comprising a plurality of dielectric nuts threaded onto the threaded outer surface thereby fixing the dielectric resonators to the support rod.

8. The dielectric filter of claim 1, wherein:
the support rod comprises a dielectric tube with a threaded outer surface;
the dielectric resonators each comprise a threaded center hole threadably receiving the threaded outer surface thereby fixing the dielectric resonators to the dielectric tube.

9. The dielectric filter of claim 1, wherein the support rod comprises a threaded central bore and further comprising:
tuning screws threadably inserted into the threaded central bore proximate to each of the dielectric resonators.

10. A dielectric filter, comprising:
a plurality of dielectric resonators; and
a plurality of dielectric rods, each of the dielectric rods supporting more than one of the dielectric resonators.

11. The dielectric filter of claim 10, wherein each of the dielectric rods comprise a threaded outer surface and further comprising:
dielectric nuts threadably fixing the dielectric resonators to the dielectric rods.

12. The dielectric filter of claim 11, wherein the dielectric rods and the dielectric nuts comprise dielectric materials with a dielectric constant ranging from 1.5 to 6, a loss tangent ranging from 0.005 to 0.00005, and a thermal expansion coefficient from −10 ppm/c to +10 ppm/c.

13. The dielectric filter of claim 10, further comprising:
a housing having more than one wall receiving each end of the dielectric rods;
more than one tuning assembly attached to the housing proximate to each of the dielectric resonators, the tuning assembly comprising:
a tuning screw made of metal;
lock nuts made of metal; and
a tuning plate having a circular shape.

14. The dielectric filter of claim 13, further comprising
a dividing wall attached to the housing thereby partially isolating the dielectric resonators.

15. The dielectric filter of claim 14, further comprising:
a cross coupling apparatus coupling a pair of the partially isolated dielectric resonators, the cross coupling apparatus including
a coaxial transmission line having rods extending from an inner conductor,
a plate attached to the inner conductor of the coaxial transmission lines, and
a ring attached to the inner conductor of the coaxial transmission lines and an outer connector of the coaxial transmission line.

16. The dielectric filter of claim 13, wherein the housing comprises metal.

17. The dielectric filter of claim 13, wherein the housing comprises a dielectric with a metal plating.

18. A diplexer, comprising:
a housing;
a reception bandpass filter that includes twelve ceramic dielectric resonators on more than one receive channel support rod, each of the more than one receive channel support rod having each end attached to the housing; and
a transmission bandpass filter that includes six metal dielectric resonators on a transmit channel support rod, the transmit channel support rod having each end attached to the housing.

19. A method of manufacturing a dielectric filter that includes a plurality of dielectric resonators, a support rod, and a housing, the method comprising:
fixing the dielectric resonators to the support rod; and
attaching each end of the support rod to the housing.
